(19) United States
(12) Patent Application Publication
(10) Pub. No.: US 2019/0008017 A1
(43) Pub. Date: Jan. 3, 2019

(54) DISCOVERY MESSAGE AND PROVISIONING REQUEST INTERFACE FOR LIGHTING NETWORKS

(71) Applicant: Echelon Corporation, Santa Clara, CA (US)

(72) Inventors: Sohrab MODI, Oakland, CA (US); Mark KEATING, Clearwater, FL (US); Glen M. RILEY, Saratoga, CA (US); Jonathan LLOYD, Sacramento, CA (US); Jwalant DHOLAKIA, Safety Harbor, FL (US); John G. WACLAWSKY, Alpine, WY (US)

(73) Assignee: Echelon Corporation, Santa Clara, CA (US)

(21) Appl. No.: 15/639,451

(22) Filed: Jun. 30, 2017

(51) Int. Cl. H05B 37/02; H04L 29/08; H04W 8/00; H04L 12/24

(52) U.S. Cl. CPC H05B 37/0227; H04L 41/0803; H04W 8/005; H04L 67/12

(57) ABSTRACT

Example embodiments of an invention to efficiently organize and control a distributed lighting network. A process supports message flows and an interface to facilitate the organization and control a very large array of intelligent lighting nodes. Each newly installed lighting node broadcasts an initial contact message that includes fields specifying requests, such as lighting schedule, intensity, color, aiming direction, flood lighting, etc. A central controller receives the message at a discovery message and provisioning request interface, commissions the lighting node, and processes the provisioning requests.

### FIELD OF THE INVENTION

The invention disclosed broadly relates to message flows during the initial organization of a distributed lighting network and after any moves, adds and deletes, and more particularly relates to efficiently organizing and controlling a large array of intelligent lighting nodes. Each newly installed or relocated node broadcasts one or more initial contact messages with fields representing connection and provisioning requests. A central controller receives these messages from new or recently relocated nodes, in a discovery message and provisioning request interface, and processes these messages, which are necessary for successful, full capability, connections to the network.

### BACKGROUND OF THE INVENTION

Currently, the lighting nodes in a large lighting network are configured through an expensive combination of error prone on-site manual settings along with complex network interactions by an installing technician. The complexity of today's installation process often leaves network control and individual network nodes in unintended states, simply based on the skill of the installer and the wide array of possible interactions with software at a central management system. These unintended states may inhibit further control, limit lighting schedule options or frustrate the ability to change or update a node without expensive manual intervention at the lighting node site. The typical business goal is to allow only authorized nodes to successfully connect to the network and provision them with required options, starting settings and default schedules. Then, optionally later, the system administrator commissions the nodes, usually after all the nodes are installed.

What is needed is a more efficient process and a more capable and flexible interface for organizing and controlling modern networked lighting.

### SUMMARY OF THE INVENTION

Example embodiments of the invention organize and control a distributed lighting network. A process allows the organization of a lighting network to control a very large number of intelligent lighting nodes. Each newly installed or re-located lighting node broadcasts a wired or wireless message that may be a discovery message or any kind of initial contact message. The wireless message, hereinafter referred to as the wireless discovery message, comprises one or more information packets, which includes fields specifying provisioning requests, such as options, lighting schedule, intensity, color, aiming direction, flood lighting, etc. A central controller receives the discovery message at a discovery message and provisioning request interface, commissions the lighting node, and processes the provisioning requests. In some embodiments, there may be one or more relay nodes that relay the discovery message from the lighting node to the central controller.

In accordance with an example embodiment of the invention, a system provides for discovery and provisioning of lighting nodes in a lighting network. A wired or wireless network is configured to control a large array of lighting nodes. Lighting nodes in the network, are configured to broadcast discovery messages that include at least one field specifying its provisioning requests.

An example lighting node includes a discovery message encoder that is configured to encode a discovery message that comprises one or more information packets, which includes at least one field specifying provisioning requests of the lighting node. The lighting node includes a wired or wireless communications unit coupled to the encoder, which is configured to broadcast the discovery message in a network that includes a central controller configured to receive the discovery message, commission the lighting node, and process the provisioning requests in accordance with the at least one field of the discovery message.

The system further includes the central controller in the wired or wireless network, which is configured to receive the discovery message, commission the at least one lighting node, and process the provisioning requests in accordance with the at least one field of the discovery message.

An example central controller includes a wired or wireless communications unit, configured to receive at least one discovery message broadcast by at least one lighting node in a network, the discovery message including at least one field specifying provisioning requests of the at least one lighting node. The central controller includes a discovery message decoder coupled to the wired or wireless communications unit, which is configured to decode the received at least one discovery message, commission the at least one lighting node, and process the provisioning requests in accordance with the at least one field of the at least one discovery message.

Lighting nodes, motion detector nodes, camera and other types of nodes and the central controller coordinate their activity via the discovery message and provisioning request interface. This interface allows network devices to attach to the network as they become increasingly more sophisticated and support new functions without having to re-provision or reorganize any other part of the lighting network. This interface is designed to be future-proof with the ability to support anticipated lighting node functions, such as weather specified lighting, colors, and intensities, and to support aiming to facilitate and control cooperative device operations where cameras, motion detectors and other devices coordinate their behavior to satisfy unique lighting and security needs.

### DESCRIPTION OF THE FIGURES

FIG. 1 illustrates an example network diagram of the central lighting controller coupled over a wired or wireless network to a plurality of lighting nodes, and is shown receiving a discovery message broadcast by a lighting node, specifying provisioning requests of the lighting node.

FIG. 2 illustrates an example embodiment of the invention, wherein the central lighting controller checks the provisioning fields and if the lighting node is on a white list, commissions the lighting node, and is shown distributing a provision response message to the lighting node, in response to receiving the discovery message.

FIG. 3 illustrates an example embodiment of the invention, showing an example lighting node device connected to the network. The lighting node device encodes a discovery message that comprises one or more information packets, which includes at least one field specifying provisioning requests of the lighting node, and broadcasts the discovery message in a wired or wireless network that includes the central lighting controller.

FIG. 4A illustrates the lighting node device N1 encoding the discovery message and provisioning request. The provisioning requests specified in the discovery message include at least one field for start settings of the at least one lighting node, including options and lighting level, color, aiming, flood, season, or weather. The provisioning requests specified in the discovery message may also include at least one field for default schedules of the at least one lighting node, including lighting level, color, aiming, flood, season, or weather.

FIG. 4B illustrates the central lighting controller decoding the discovery message and provisioning request and commissioning the lighting node device, setting options and providing provisioning and scheduling for the lighting node device.

FIG. 4C illustrates the central lighting controller encoding the provisioning response message to assign settings and schedules for the lighting node device.

FIG. 5A illustrates an example flow diagram 500 of steps performed by the lighting node for encoding a discovery message.

FIG. 5B illustrates an example flow diagram 550 of steps performed by the central controller for discovery and provisioning of lighting nodes in a lighting network.

### DISCUSSION OF THE PREFERRED EMBODIMENTS

Example embodiments of the invention organize and control a distributed lighting network. A process allows the efficient organization and control of large lighting networks of intelligent lighting nodes. Enabled options, starting settings and default schedules may be initially established in a lighting node device as factory settings or they may be set by the installer at the time of the node's installation. For example, the installer may enter into the lighting node device, the node ID, the metes and bounds of the lighted area to be covered, and starting settings for light level, color, and aiming of the light. There may be factory settings for default schedules for light level, for example, as nighttime “on” and daytime “off”. In accordance with the invention, after installation, each newly installed lighting node wired or wirelessly broadcasts one or more discovery messages that include fields specifying provisioning requests to a central lighting controller, requesting the controller to either confirm the installed settings or to over-ride the installed settings with assigned new settings. The central controller receives the one or more discovery messages, checks whether the requesting node is on a white list, authenticates the node (expected node type, enabled options and manufacturer etc.), commissions the lighting node as a valid node in the lighting network, and processes the provisioning requests.

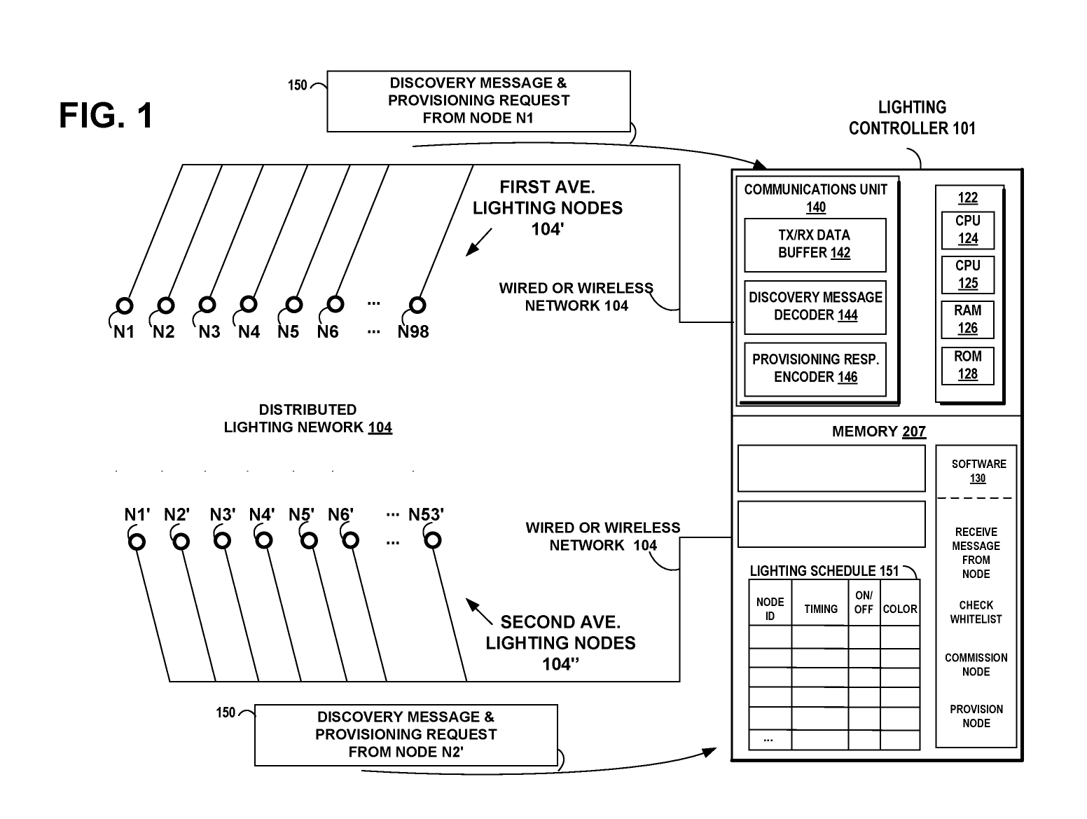

FIG. 1 illustrates an example network diagram of the lighting controller 101. The lighting controller 101 controls lighting node options and the scheduling and lighting patterns of a plurality of lighting node devices in the distributed lighting network 104.

The central lighting controller 101 includes a wired or wireless communications unit 140, configured to receive at least one discovery message 150 broadcast by at least one lighting node N1 in a wired or wireless network 104. The discovery message 150 includes at least one field specifying provisioning requests of the at least one lighting node N1. The discovery message 150 may comprise one or more information packets. The central lighting controller 101 further includes a discovery message decoder 144 coupled to the communications unit 140, configured to decode the received at least one discovery message 150, commission the at least one lighting node N1, and process the provisioning requests in accordance with the at least one field of the at least one discovery message 150. The central lighting controller 101 further includes a provisioning response encoder 146 to encode a provisioning response message to be sent to the lighting node device, to either confirm the installed settings in the node or to over-ride the installed settings with assigned new settings.

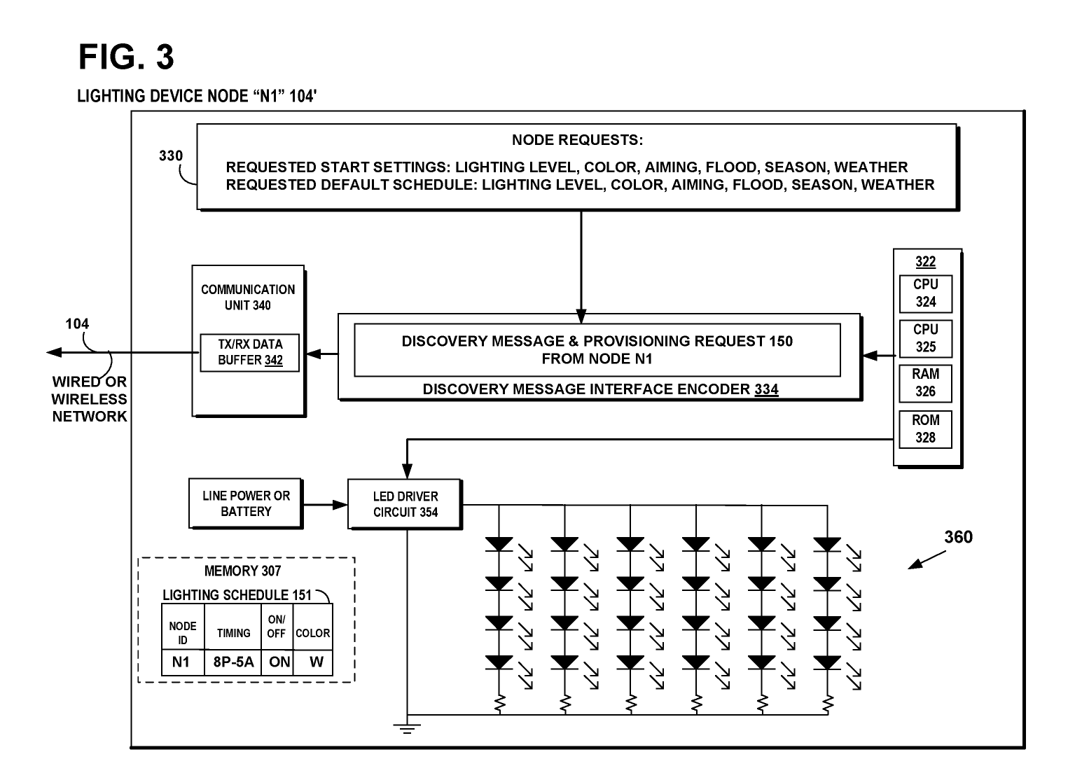

There may be a plurality of lighting node devices in the distributed lighting network 104. Lighting node devices N1, N2, N3, N4, N5, N6, . . . N98 are in a first branch 104′ along First Ave. and lighting node devices N1′, N2′, N3′, N4′, N5′, N6′, . . . N53′ are in a second branch 104″ along Second Ave. Other branches, not shown, could light up parks, bridges, bike and hiking trails, parking lots, etc. Each lighting device includes an LED lighting array and digital components shown in FIG. 3.

The lighting controller 101 includes a processor 122 comprising a dual central processor unit (CPU) or multi-CPU 124/125, a random access memory (RAM) 126 and read only memory (ROM) 128. The memories 126 and/or 128 include computer program code, including control software 130. The lighting controller 101 includes the lighting schedule 151 in the memory 207. The lighting controller 101 includes a wired or wireless communications unit 140 that includes a transmit/receive (TX/RX) buffer 142, the discovery message decoder 144, and the provisioning response encoder 146, which is configured to communicate with the lighting node devices 104′ and 104″ via the network 104. Other examples of the network 104, include twisted pair, coax cable, Ethernet, Infrared, RFID, WiFi, Bluetooth, Bluetooth Low Energy, ultra-narrow band communications protocol from Sigfox, LTE-M, any Low Power Wireless Area Network (LPWAN) protocol, any M2M communication protocol, cellular, IEEE 802.15.4 RF, or LoRa Low Power Wide Area Network. The lighting controller 101 may include a radio communications unit that includes a transmit/receive (TX/RX) buffer a cell phone transceiver and a WiFi transceiver to communicate with the lighting node devices 104 via radio communications units in the devices.

The lighting controller 101 includes program software 130 in the memory 207, to receive the discovery message from a lighting node. The program software 130 checks for valid options and whether the discovery message indicates that the node's ID is on a white list. The program software 130 checks whether the discovery message indicates that the node is associated with a camera or motion detector. The program software 130 checks whether the discovery message indicates the correct model and manufacturer. The program software 130 then commissions the lighting node, and provisions the lighting node with the lighting parameters and schedules requested in the discovery message or specified by the central controller. Optionally the program software can cause the activation of lighting node options, such as linkage to one or more cameras or motion detectors.

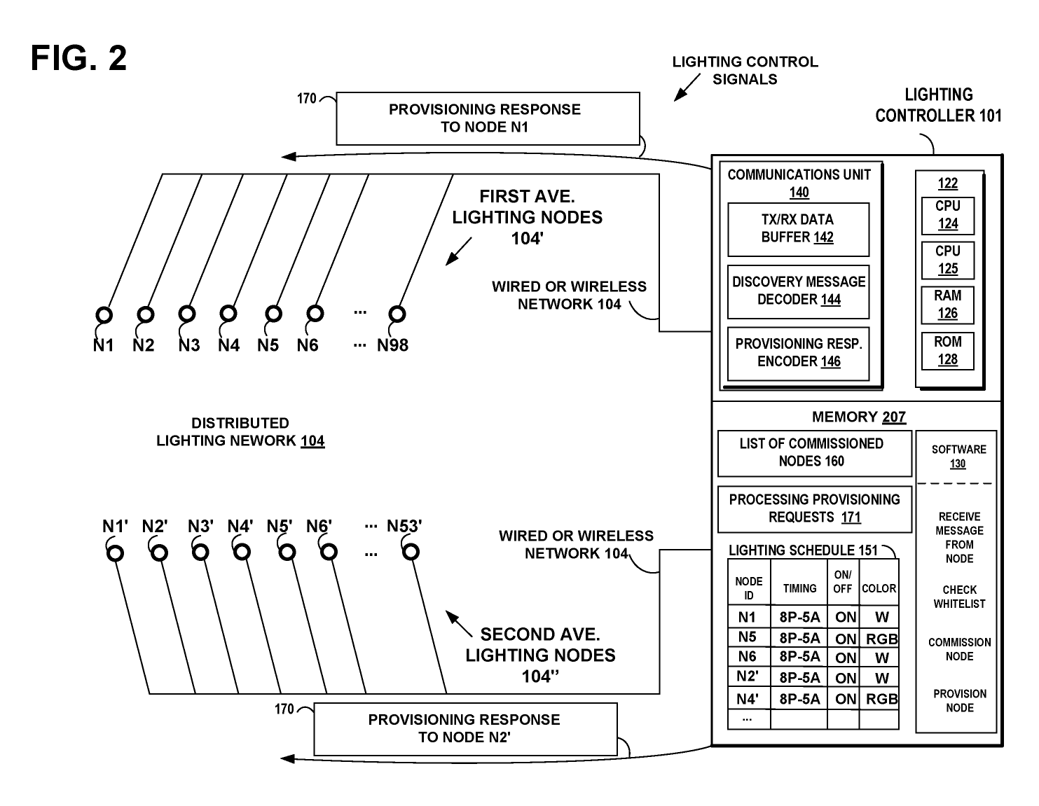

FIG. 2 illustrates the example embodiment of the invention in FIG. 1, wherein the processor 122 in the lighting controller 101, is programmed to generate a message specifying the provision response message 170, which may include a modified lighting schedule or cause the activation of lighting node options such as an association with nearby cameras or motion detectors. In addition, the provision response message 170 may include a light group assignment. The provision response message 170 may be based on received weather forecast datasets. The provision response message 170 may include at least one of changing times for lighting to go on or off, changing color/frequency of the lighting, brightening intensity in response to a severe storm, choosing a softer intensity in response to a moderate storm, changing the dimming setting, or changing rate of onset of light change. The provision response message 170 may over-ride and change the requested light level and requested lighting schedule, to accommodate a surveillance camera nearby the lighting node, to improve safety and security. Also the provision response message may adjust the metes and bounds of the light, adjust lighting characteristics or reassign the lighting group, in response to signals from motion detectors or cameras to improve safety and security. The provision response message 170 may comprise one or more information packets.

In accordance with embodiments of the invention, lighting controller 101 may be further configured to distribute provision response messages 170 to the distributed lighting network 104 to modify the lighting schedule 151, based on lunar phases, amount of cloud cover or level of starlight, in combination with the received weather forecast datasets 160.

In accordance with embodiments of the invention, lighting controller 101 may be further configured to distribute provision response messages 170 to the distributed lighting network 104 to modify the lighting schedule 151, based on changing spectral range of lighting to enhance visual acuity during periods of cloudiness, weather events or overcast.

In accordance with embodiments of the invention, lighting controller 101 may be further configured to distribute provision response messages 170 to the distributed lighting network 104 to modify the lighting schedule 151, based on changing lighting intensity to enhance night vision during periods of cloudiness, weather events or overcast.

In accordance with embodiments of the invention, lighting controller 101 may be further configured to distribute provision response messages 170 to the distributed lighting network 104 to modify the lighting schedule 151, based on changing brightness or spectral range of lighting to counteract a mood of depression due to seasonal affective disorder during periods of cloudiness, weather events or overcast.

FIG. 3 illustrates an example embodiment of the invention, showing an example lighting device N1 connected to the network 104. The lighting node device includes an example copy of a lighting schedule 151 in its memory 307, as its current schedule. The lighting node device N1 normally follows the schedule 151. The buffer 330 contains the starting settings and default schedules that were initially established as factory settings or that were set by the installer at the time of the node's installation. For example, the installer may have entered into the buffer 330, the node ID, the metes and bounds of the lighted area to be covered, associations with cameras or motion detectors and starting settings for light level, color, and aiming of the light. There may have been factory settings entered in buffer 330 for default schedules for light level, for example, as nighttime “on” and daytime “off”. The lighting node device N1 includes a discovery message encoder 334 that is configured to encode a discovery message 150 that includes at least one field specifying the settings in the buffer 330 as provisioning requests, including a potential group assignment or camera and motion detector associations. The discovery message 150 may comprise one or more information packets. The lighting node device includes a wired or wireless communications unit 340 coupled to the encoder 334, which is configured to broadcast the discovery message 150 in the network 104. The network 104 includes the central lighting controller 101 configured to receive the discovery message 150, commission the lighting node N1, and process the provisioning requests in accordance with the at least one field of the discovery message 150. The discovery message 150 requests the controller to either confirm the installed settings in the node or to over-ride the installed settings with assigned new settings.

The example lighting device N1 shown in FIG. 3, includes a wired or wireless communications unit 340 that includes a transmit/receive (TX/RX) buffer 342, which is configured to communicate with the lighting controller 101 via the network 104. The device N1 activates the LED driver circuit 354 controlled by the processor 322, to power the LED light array 360 from line power or battery. Depending on the control parameters in the lighting schedule 151, the light array 360 may be turned on, its illumination level adjusted, its color changed, or turned off, in response. The LED driver circuit 354 controls the voltage and current patterns sent to each LED element (Red, Green, Blue) in the LED array 360. The LED array 360 may be a single light fixture with a plurality of Red, Green and Blue LEDs contained in the light fixture, or it may be an array of LED's.

As discussed above, the provision response message 170 received from the central lighting controller 101, may over-ride options and change the requested light level and requested lighting schedule requested in the discovery message 150. For example, the provision response message 170, may over-ride and change a requested light level and requested lighting schedule to accommodate a surveillance camera nearby the lighting node, to improve safety and security. It may change associations with motion detectors. In another example, the provision response message 170, may over-ride and change a requested first association with a first lighting node group, to a second association with a second lighting node group, to adjust areas to be illuminated, improving safety and security, or to effect energy savings.

The example lighting device N1 includes a processor 322 comprising a dual central processor unit (CPU) or multi-CPU 324/325, a random access memory (RANI) 326 and read only memory (ROM) 328. The memories 326 and/or 328 include computer program code for responding to lighting control information messages 170 from the lighting controller 101.

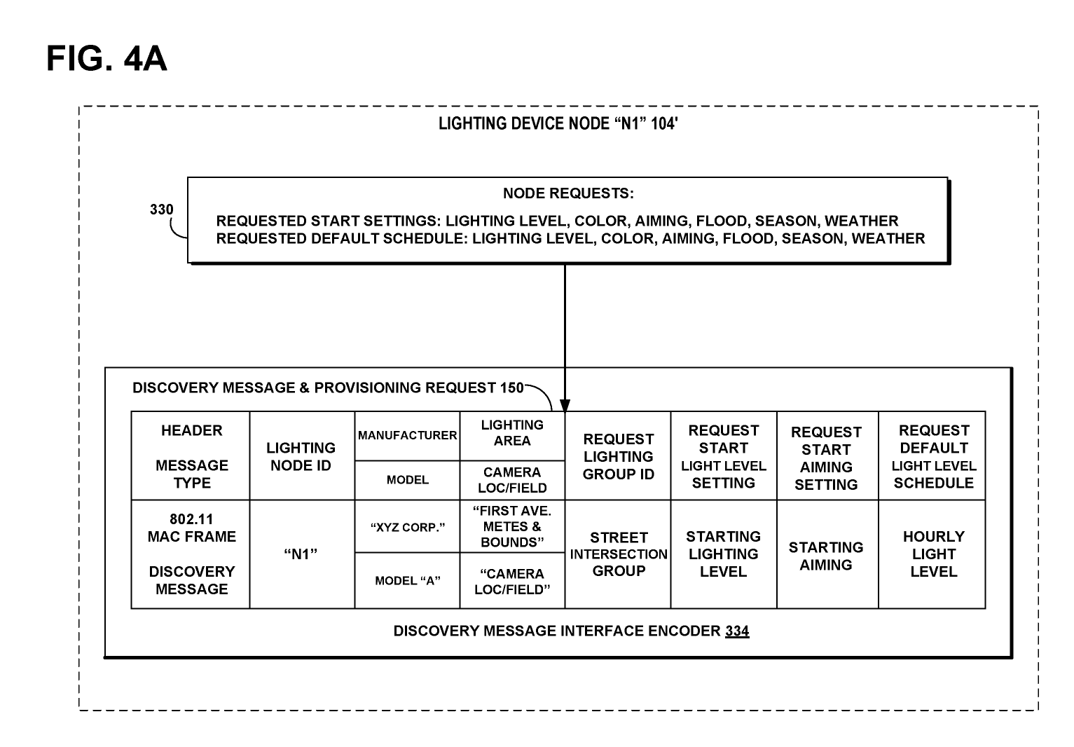

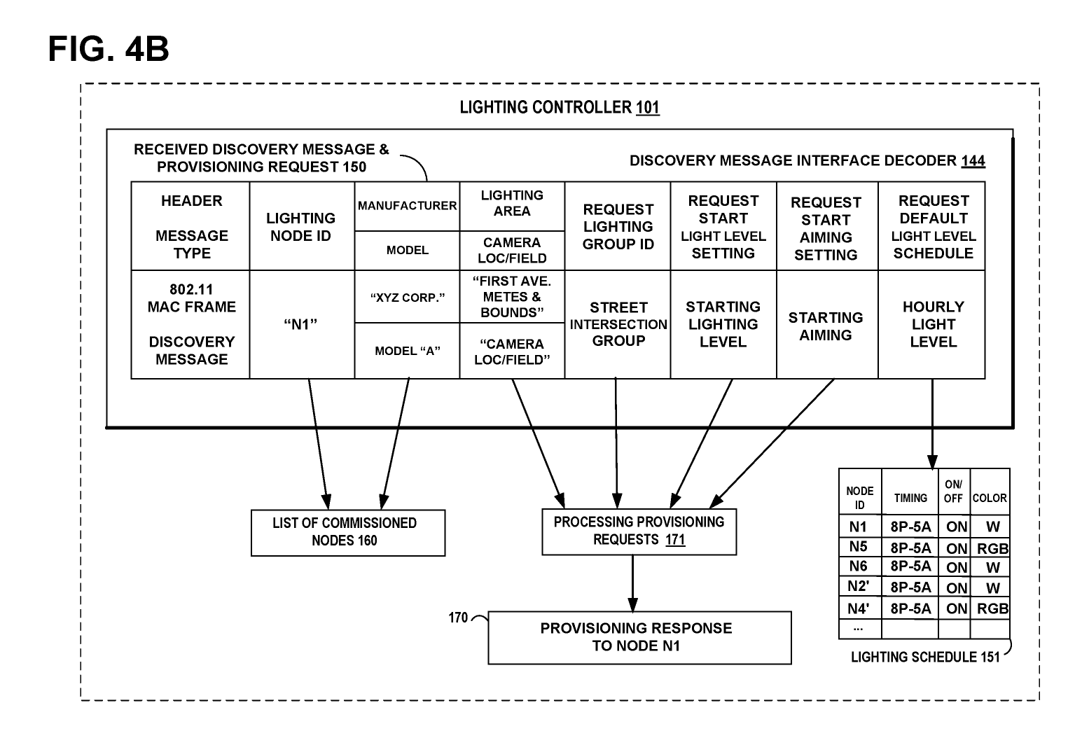

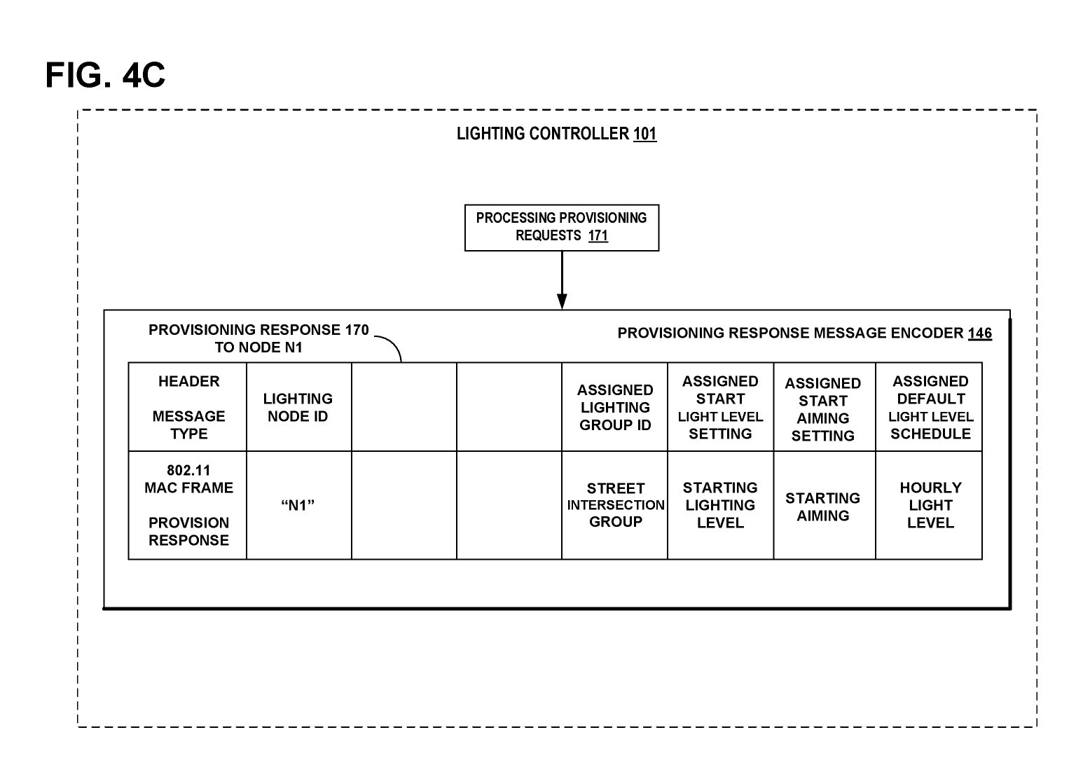

FIG. 4A illustrates the lighting node device N1 encoding the discovery message and provisioning request in the discovery message interface encoder 334. Parameters to be encoded into the discovery message of the node N1, may be initially entered into the buffer 330 as factory settings or they may be set by the installer at the time of the node's installation. These parameters are then transferred from the buffer 330 to the discovery message interface encoder 334. The encoded discovery message 150 includes fields for the lighting node ID, the manufacturer and model of the lighting node N1, the area illuminated by the lighting node N1, and the location and field of coverage of proximate cameras or motion detectors, if any. The provisioning requests in the buffer 330, which are to be encoded into the discovery message, may include at least one field for start settings of node N1, including lighting group assignment, lighting level, color, aiming, flood, season, or weather, for example. The provisioning requests in the buffer 330 to be encoded in the discovery message 150 may also include at least one field for default schedules of node N1, including group assignment, camera and motion detector associations, lighting level, color, aiming, flood, season, or weather, for example. The example shown in the figure provides a header field specifying the message type as an IEEE 802.11 MAC frame discovery message. The discovery message 150 may comprise one or more information packets. Example fields that may be set by the installer specify the lighting node ID as “N1” and specify the lighting area as the metes and bounds of “First Ave.” Example fields that may be set either by the installer or as factory settings, specify requests for starting lighting group assignment, light level, starting color, starting aiming, default light level schedule, and default aiming schedule.

FIG. 4B illustrates the central lighting controller 101 decoding the discovery message and provisioning request 150 in the discovery message interface decoder 144. The central lighting controller 101 checks lighting node options and whether the requesting node is on a white list and meets per-designated manufacturer and model criteria and is associated with nearby cameras and motion detectors. The central lighting controller 101 then commissions the lighting node as a valid node in the lighting network and adds it to the list of commissioned nodes 160. The central lighting controller 101 processes the provisioning requests 171 and encodes the provisioning response message 170. The parameters in the lighting schedule 151 are updated with the existing settings reported in the discovery message 150 and any assignments of new settings in the provisioning response message 170. Processing of the provisioning requests may include assigning at least one lighting node to a specific grouping of lights or other devices, where the specific grouping of lights is coordinated in at least one of color, intensity, aiming, spectral range, lighting schedule, or coordination with one or more cameras or motion detectors. In some embodiments, a light group may include a group of cooperating devices whose functions may be coordinated from the central controller, for example associating lights with nearby motion detectors and cameras to provide safety and security.

Certain fields in the discovery message and provisioning request 150 may use verbs that may be decoded as message codes in the central lighting controller 101. For example, the camera field identified as “CAMERA LOC/FIELD” in FIG. 4B may be expressed as a data structure, i.e., a composite data type or sequence of values [a, b, c] that defines a similarly grouped sequence of messages [msg(a), msg(b), msg(c)]. For example, the verb “a” may represent the type of surveillance device: either camera or motion detector. The verb “b” may represent a color of illumination by node N1, if the verb “a” indicates a camera or the verb “b” represents either acoustic or infrared detection, if the verb “a” indicates a motion detector. The verb “c” may represent timing for the surveillance device: either always on or scheduled on/off,

For example, if the node N1 has a camera or motion detector proximately located to it, this will be represented by the first verb “a”. A video camera is represented by “a=1”. A motion detector is represented by “a=2”. If there is no camera or motion detector, then “a=0”.

The corresponding message [msg(a)] for the verb “a=1” is the following sequence:
(1) access video camera location database and store location (lat/lon) of the camera;
(2) read “LIGHTING AREA” field of discovery message 150 for location (lat/lon) of node N1;
(3) calculate the aiming setting needed to point the illumination of node N1 toward the location the video camera is pointed;
(4) encode the over-ride aiming setting in the assigned “START AIMING SETTING FIELD” of the provisioning response message 170.
The corresponding message [msg(a)] for the verb “a=2” is the following sequence:
(1) access motion detector location database and store location (lat/lon) of detector;
(2) read “LIGHTING AREA” field of discovery message 150 for location of node N1;
(3) calculate the aiming setting needed to point the illumination of node N1 near the location of the motion detector;
(4) encode the over-ride aiming setting in the assigned “START AIMING SETTING FIELD” of the provisioning response message 170.
The corresponding message [msg(a)] for the verb “a=0” is:
(1) No action.

FIG. 4C illustrates the central lighting controller 101 encoding the provisioning response message 170 in the provisioning response message encoder 146, to either confirm the existing settings in the lighting node device N1 or to assign new settings and schedules for the lighting node device N1. The example shown in the figure provides a header field specifying the message type as an IEEE 802.11 MAC frame provision response message. Example fields that may be encoded by the provisioning response message encoder 146 specify the lighting node ID as “N1” and specify the starting lighting group assignment, light level, starting color, starting aiming, default light level schedule, and default aiming schedule. The provisioning response message 170 may comprise one or more information packets.

In an example embodiment of the invention, the central lighting controller 101 may confirm that a request from a lighting node N1 is valid, for example that the requesting node has the correct options and a capability to use the settings it is requesting. For example, if a requesting node N1 represents in its discovery message 150, that it is associated with a camera or motion detector, then the central lighting controller 101 may check a database of surveillance equipment locations to confirm whether surveillance equipment is actually located near to the requesting node. If the requesting node is determined to not be authorized to make the request it has represented in its discovery message 150, then the central lighting controller 101 may reject the attempt by the node to connect to the network 104.

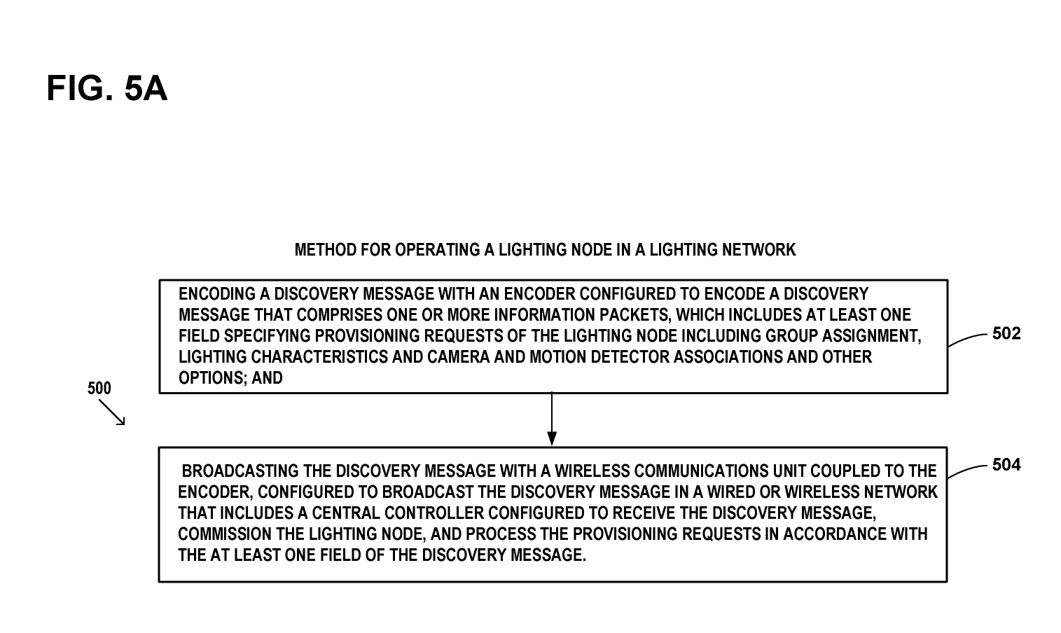

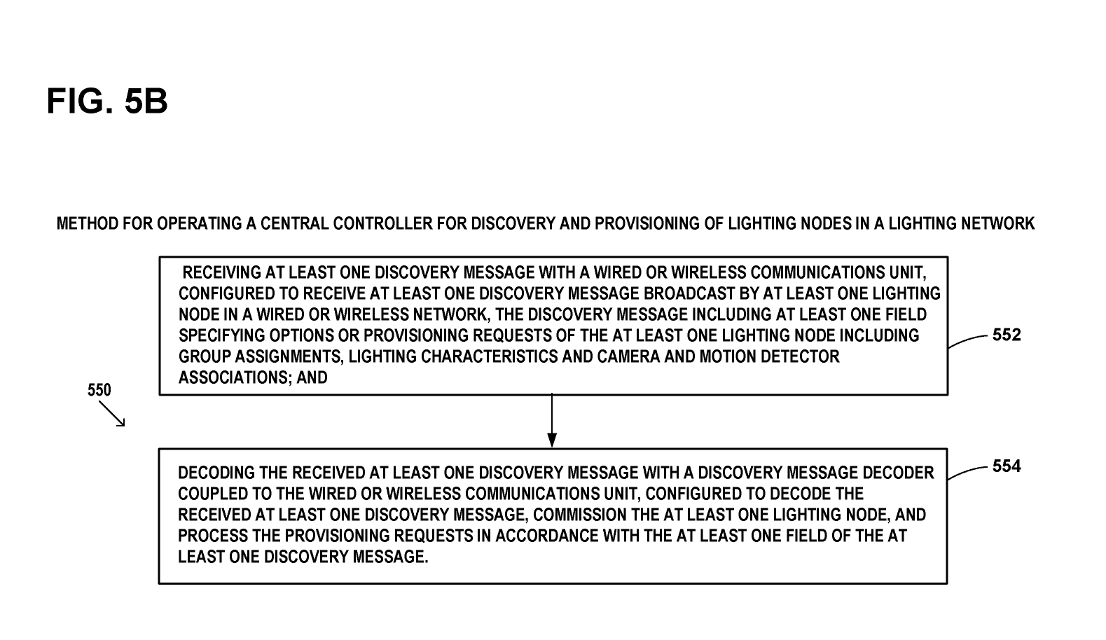

FIG. 5A illustrates an example flow diagram 500 of steps performed by the lighting node for encoding a discovery message. The steps of the flow diagram 500 represent computer code instructions stored in the RAM and/or ROM memory, which when executed by the central processing units (CPU), carry out the functions of the example embodiments of the invention. The steps may be carried out in another order than shown and individual steps may be combined or separated into component steps. The flow diagram has the following steps:

Step 502: encoding a discovery message with an encoder configured to encode a discovery message that comprises one or more information packets, which includes at least one field specifying provisioning requests of the lighting node including group assignment, lighting characteristics and camera and motion detector associations and other options; and

Step 504: broadcasting the discovery message with a wireless communications unit coupled to the encoder, configured to broadcast the discovery message in a wired or wireless network that includes a central controller configured to receive the discovery message, commission the lighting node, and process the provisioning requests in accordance with the at least one field of the discovery message.

FIG. 5B illustrates an example flow diagram 550 of steps performed by the central controller for discovery and provisioning of lighting nodes in a lighting network. The steps of the flow diagram 550 represent computer code instructions stored in the RAM and/or ROM memory, which when executed by the central processing units (CPU), carry out the functions of the example embodiments of the invention. The steps may be carried out in another order than shown and individual steps may be combined or separated into component steps. The flow diagram has the following steps:

Step 552: receiving at least one discovery message with a wired or wireless communications unit, configured to receive at least one discovery message broadcast by at least one lighting node in a wired or wireless network, the discovery message including at least one field specifying options or provisioning requests of the at least one lighting node including group assignments, lighting characteristics and camera and motion detector associations; and

Step 554: decoding the received at least one discovery message with a discovery message decoder coupled to the wired or wireless communications unit, configured to decode the received at least one discovery message, commission the at least one lighting node, and process the provisioning requests in accordance with the at least one field of the at least one discovery message.

Although specific example embodiments of the invention have been disclosed, persons of skill in the art will appreciate that changes may be made to the details described for the specific example embodiments, without departing from the spirit and the scope of the invention.

What is claimed is:

1. A lighting node in a lighting network, comprising:
a discovery message encoder configured to encode a discovery message that comprises one or more information packets, which includes at least one field specifying provisioning requests of the lighting node in the lighting network; and
a wired or wireless communications unit coupled to the encoder, configured to broadcast the discovery message in a wired or wireless network that includes a central controller configured to receive the discovery message, commission the lighting node in the lighting network, and process the provisioning requests in accordance with the at least one field of the discovery message.

2. The lighting node of claim 1, wherein the provisioning requests specified in the discovery message include at least one field for start settings of the lighting node or default schedules of the lighting node, including lighting level, color, aiming, flood, season, or weather.

3. The lighting node of claim 1, wherein the provisioning requests specified in the discovery message include a request for assignment of at least one lighting node to a light group; and
the processing of the provisioning requests includes assigning the at least one lighting node to a specific grouping of lights or other devices, where the specific grouping of lights is coordinated in at least one of color, intensity, aiming, spectral range, lighting schedule, or coordination with one or more cameras or motion detectors.

4. The lighting node of claim 1, wherein the provisioning requests specified in the discovery message include an indication of a proximate camera or motion detector; and
the processing of the provisioning requests includes coordinating lighting intensity of the at least one lighting node with detection of motion by the camera or motion detector.

5. The lighting node of claim 1, wherein the provisioning requests specified in the discovery message include verbs that are decoded as message codes in the central controller to process the provisioning requests.

6. A method for operating a lighting node in a lighting network, comprising:
encoding a discovery message with an encoder configured to encode a discovery message that comprises one or more information packets, which includes at least one field specifying provisioning requests of the lighting node in the lighting network; and
broadcasting the discovery message with a wired or wireless communications unit coupled to the encoder, configured to broadcast the discovery message in a wired or wireless network that includes a central controller configured to receive the discovery message, commission the lighting node in the lighting network, and process the provisioning requests in accordance with the at least one field of the discovery message.

7. The method for operating a lighting node of claim 6, wherein the provisioning requests specified in the discovery message include at least one field for start settings of the lighting node or default schedules of the lighting node, including lighting level, color, aiming, flood, season, or weather.

8. The method for operating a lighting node of claim 6, wherein the provisioning requests specified in the discovery message include a request for assignment of at least one lighting node to a light group; and
the processing of the provisioning requests includes assigning the at least one lighting node to a specific grouping of lights or other devices, where the specific grouping of lights is coordinated in at least one of color, intensity, aiming, spectral range, lighting schedule, or coordination with one or more cameras or motion detectors.

9. The method for operating a lighting node of claim 6, wherein the provisioning requests specified in the discovery message include an indication of a proximate camera or motion detector; and
the processing of the provisioning requests includes coordinating lighting intensity of the at least one lighting node with detection of motion by the camera or motion detector.

10. The method for operating a lighting node of claim 6, wherein the provisioning requests specified in the discovery message include verbs that are decoded as message codes in the central controller to process the provisioning requests.

11. A central controller for discovery and provisioning of lighting nodes in a lighting network, comprising:
a wired or wireless communications unit, configured to receive at least one discovery message broadcast by at least one lighting node in a wired or wireless network, the discovery message including at least one field specifying provisioning requests of the at least one lighting node in the lighting network;
a discovery message decoder coupled to the wired or wireless communications unit, configured to decode the received at least one discovery message, commission the at least one lighting node in the lighting network, and process the provisioning requests in accordance with the at least one field of the at least one discovery message.

12. The central controller of claim 11, wherein the provisioning requests specified in the discovery message include at least one field for start settings of the lighting node or default schedules of the lighting node, including lighting level, color, aiming, flood, season, or weather.

13. The central controller of claim 11, wherein the provisioning requests specified in the discovery message include a request for assignment of at least one lighting node to a light group; and
the processing of the provisioning requests includes assigning the at least one lighting node to a specific grouping of lights or other devices, where the specific grouping of lights is coordinated in at least one of color, intensity, aiming, spectral range, lighting schedule, or coordination with one or more cameras or motion detectors.

14. The central controller of claim 11, wherein the provisioning requests specified in the discovery message include an indication of a proximate camera or motion detector; and
the processing of the provisioning requests includes coordinating lighting intensity of the at least one lighting node with detection of motion by the camera or motion detector.

15. The central controller of claim 11, wherein the provisioning requests specified in the discovery message include verbs that are decoded as message codes in the central controller to process the provisioning requests.

16. A method for operating a central controller for discovery and provisioning of lighting nodes in a lighting network, comprising:
receiving at least one discovery message with a wired or wireless communications unit, configured to receive at least one discovery message broadcast by at least one lighting node in a wired or wireless network, the discovery message including at least one field specifying provisioning requests of the at least one lighting node in the lighting network;
decoding the received at least one discovery message with a discovery message decoder coupled to the wired or wireless communications unit, configured to decode the received at least one discovery message, commission the at least one lighting node in the lighting network, and process the provisioning requests in accordance with the at least one field of the at least one discovery message.

17. The method for operating a central controller of claim 16, wherein the provisioning requests specified in the discovery message include at least one field for start settings of the lighting node or default schedules of the lighting node, including lighting level, color, aiming, flood, season, or weather.

18. The method for operating a central controller of claim 16, wherein the provisioning requests specified in the discovery message include a request for assignment of at least one lighting node to a light group; and
the processing of the provisioning requests includes assigning the at least one lighting node to a specific grouping of lights or other devices, where the specific grouping of lights is coordinated in at least one of color, intensity, aiming, spectral range, lighting schedule, or coordination with one or more cameras or motion detectors.

19. The method for operating a central controller of claim 16, wherein the provisioning requests specified in the discovery message include an indication of a proximate camera or motion detector; and
the processing of the provisioning requests includes coordinating lighting intensity of the at least one lighting node with detection of motion by the camera or motion detector.

20. The method for operating a central controller of claim 16, wherein the provisioning requests specified in the discovery message include verbs that are decoded as message codes in the central controller to process the provisioning requests.

21. The method for operating a central controller of claim 16, further comprising:
confirming, by the central controller, whether the at least one lighting node is authorized to make a provisioning request in the discovery message; and
rejecting, by the central controller, the provisioning request or rejecting connection to the network, if the at least one lighting node is not authorized to make the provisioning request.

22. A system for discovery and provisioning of lighting nodes in a lighting network, comprising:
a wired or wireless network configured to control a large array of lighting nodes;
at least one lighting node in the wired or wireless network, configured to broadcast a discovery message that comprises one or more information packets, which includes at least one field specifying its provisioning requests in the lighting network; and
a central controller in the wired or wireless network, configured to receive the discovery message, commission the at least one lighting node in the lighting network, and process the provisioning requests in accordance with the at least one field of the discovery message.

23. The system of claim 22, wherein the provisioning requests specified in the discovery message include at least one field for start settings of the at least one lighting node, including lighting level or color, aiming, flood, season, or weather, and default schedules of the lighting node, including lighting level, color, aiming, flood, season, or weather.
